(19) United States
(12) Patent Application Publication
(10) Pub. No.: US 2015/0298326 A1
(43) Pub. Date: Oct. 22, 2015

(54) RAZOR WITH HEATERS BEHIND BLADES

(71) Applicants: Louis D. Tomassetti, Pompano Beach, FL (US); William Bohmer, Randolph, NJ (US)

(72) Inventors: Louis D. Tomassetti, Pompano Beach, FL (US); William Bohmer, Randolph, NJ (US)

(73) Assignees: Display Matrix Corporation, Randolph, NJ (US); L.P.I. Consumer Products, Inc., Pompano Beach, FL (US)

(21) Appl. No.: 14/254,251

(22) Filed: Apr. 16, 2014

(51) Int. Cl. B26B 21/48; B26B 21/22; B26B 21/40; B26B 21/16

(52) U.S. Cl. CPC B26B 21/48; B26B 21/16; B26B 21/222; B26B 21/405

(57) ABSTRACT

A shaving razor includes one or more heaters held in spaced, adjacent relation to the rear non-cutting edge of at least one blade of the razor. The one or more heaters are in connection with an electric power source, which may be located in the blade cartridge or in the handle of the razor. When the electric circuit is closed and electric current flows through the heaters, the heaters generate heat that is directed between the blades and towards the front cutting edge of the blades in a radiator effect. The heaters serve to warm the blades while also providing warmth to the user's skin for increased shaving performance and comfort. In a preferred embodiment, the heaters are made from a high resistance material, such as Nichrome, for producing heat with maximum efficiency.

### BACKGROUND OF THE INVENTION

1. Field of the Invention

The present invention relates to razors for shaving and, more particularly, to a razor having one or more electrically powered heaters.

2. Discussion of the Related Art

It is known that comfort during shaving and overall shaving performance are improved when the user's skin is exposed to heat during the shaving process. As such, it is common practice to place the razor blades under hot running water in order to heat the blades just prior to stroking the blades over the skin in order to cut the hairs. However, the temperature of the skin surface, hairs and blades are quickly reduced due to exposure to the ambient air. Ideally, it is best to expose the skin surface and hairs to a warm temperature throughout the shaving process to achieve better performance and increased shaving comfort.

The present invention serves to provide an efficient heating system by providing heat distribution between each razor blade in a series of razor blades. Specifically, the present invention uses one or more heaters held in spaced, adjacent relation to the back non-cutting edge of the razor blades for directing heat towards the cutting edge of the razor blades.

### SUMMARY OF THE INVENTION

The present invention is directed to a shaving razor including one or more heaters held in spaced, adjacent relation to the rear non-cutting edge of at least one blade of the razor. The one or more heaters are in connection with an electric power source, which may be located in the blade cartridge or in the handle of the razor. When the electric circuit is closed and electric current flows through the heaters, the heaters generate heat that is directed between the blades and towards the front cutting edge of the blades in a radiator effect. The heaters serve to warm the blades while also providing warmth to the user's skin for increased shaving performance and comfort. In a preferred embodiment, the heaters are made from a high resistance material such as, for instance, Nichrome (an alloy of metal, chromium, and iron), for producing heat with maximum efficiency.

### OBJECTS AND ADVANTAGES OF THE INVENTION

Considering the foregoing, it is a primary object of the present invention to provide a razor with heaters behind the blades for directing heat between the blades towards the front cutting edge of the blades and the user's skin.

It is a further object of the present invention to provide a heating system in a razor that efficiently heats the blades secured in the blade cartridge while providing warmth to the user's skin for increased shaving comfort.

These and other objects and advantages of the present invention are more readily apparent with reference to the following detailed description and the accompanying drawings.

### BRIEF DESCRIPTION OF THE DRAWINGS

For a fuller understanding of the nature of the present invention, reference should be made to the following detailed description taken in conjunction with the accompanying drawings in which:

FIG. 1 is a top plan view, shown in partial cross-section, illustrating the electric circuit and heaters behind the blades of the razor of the present invention;

FIG. 2 is a bottom plan view of the razor of the present invention;

FIG. 3 is a top plan view illustrating one embodiment of the razor of the present invention;

FIG. 4 is a cross-sectional view taken along the plane of the line 4-4 illustrating the heating system for a razor of the present invention and including the series of razor blades, a staple, an insulating material, a thin conductive film located between the staple and the blades, the heaters behind the razor blades, and the blade cartridge housing; and

FIG. 5 is a cross-sectional view illustrating another embodiment of the heating system for a razor of the present invention and including the series of razor blades, a staple, an insulating material, a thin conductive film located between the staple and the blades, a heater behind the razor blades, and the blade cartridge housing.

Like reference numerals refer to like parts throughout the several views of the drawings.

### DETAILED DESCRIPTION OF THE PREFERRED EMBODIMENTS

Referring to the several views of the drawings, the heated razor of the present invention is shown and is generally indicated as 10.

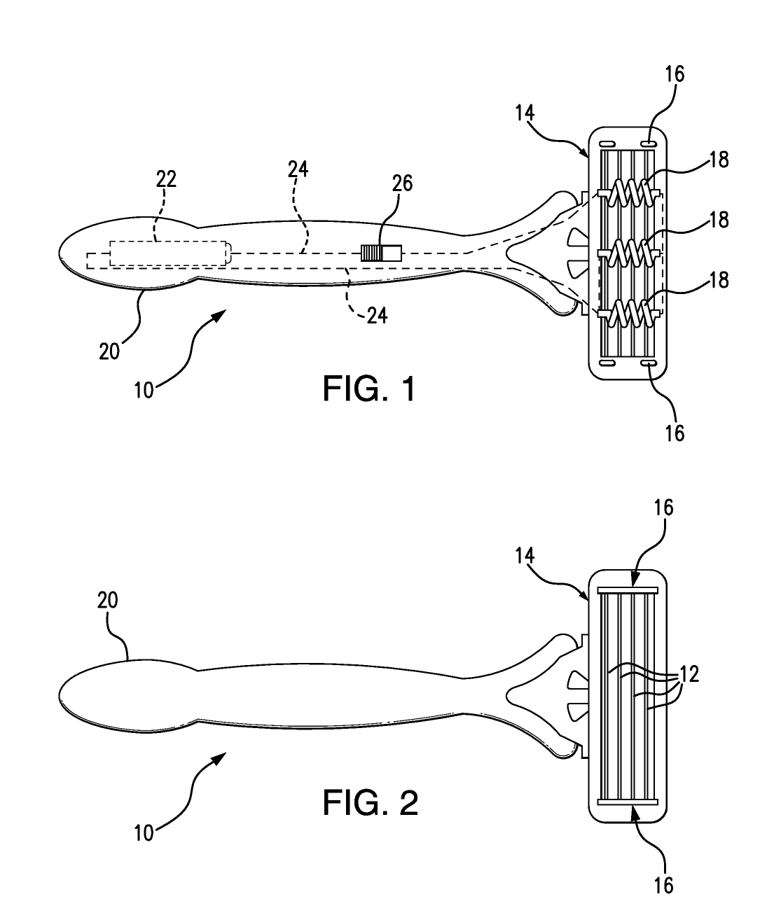

Referring initially to FIGS. 1 and 2, the razor 10 includes a series of razor blades 12 affixed in parallel relation to each other in a blade cartridge 14. In one embodiment, a pair of staples 16 located at opposite side of the blade cartridge 14 holds the razor blades 12 in place. One or more heaters 18 are held in the blade cartridge 14 adjacent to the back surface of the razor blades 12. In one embodiment, the one or more heaters 18 are a closed coil heating elements made from an electrically conductive material having a high resistance, such as, but not limited to, Nichrome, in order to generate heat when electric current flows through the heaters 18 while also controlling thermal runaway. Other heater shapes, such as, but not limited to, open coil, zig-zag, S-curve, triangles, circular or straight shaped heating elements may be used as well.

The blade cartridge 14 may be affixed to a handle 20 in a manner wherein the entire razor 10 is disposed of after several uses for shaving. Alternatively, the blade cartridge 14 may be removably attachable to a handle 20 wherein the blade cartridge 14 is separated from the handle 20 and discarded after several uses when the blades 12 begin to dull. Thereafter, a new blade cartridge 14 can be attached to the handle 20. An electric power source (e.g., a battery) 22 in the handle 20 or blade cartridge 14 provides an electric current flow through the circuit of the heating system, including conductive wires 24 and the heaters 18. The razor 10 includes an ON/OFF switch 26 on the handle 20 or the blade cartridge 14 for activating and deactivating the heating system. Operation of the switch 26 to the ON condition serves to close the circuit and activate the heaters 18.

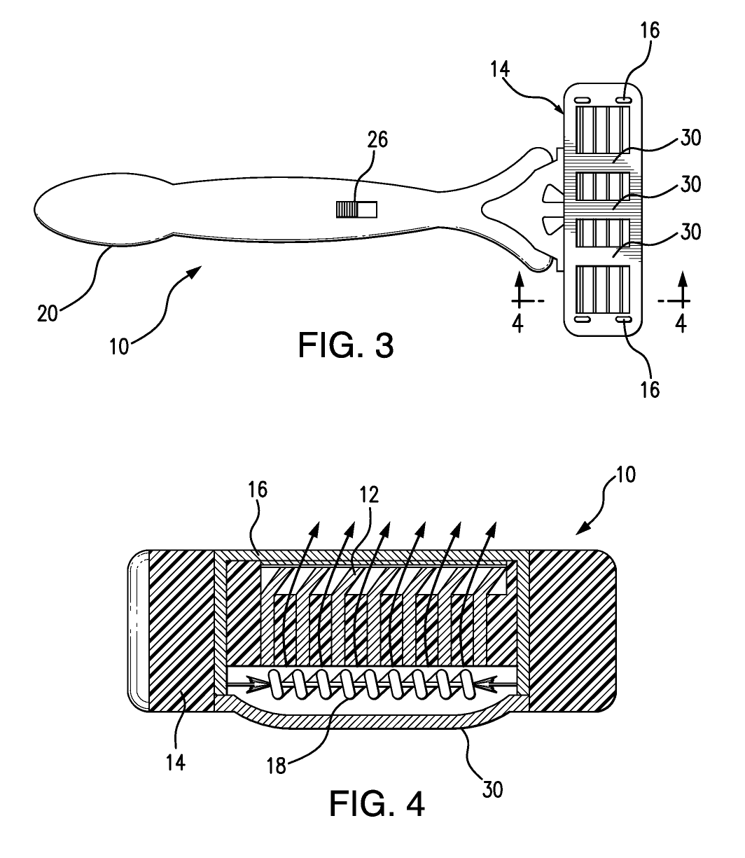

Referring to FIGS. 3 and 4, the back side of the blade cartridge 14 may include covers 30 for shielding the heaters 18 from direct contact with rinse water. A preferred embodiment of the razor includes one or more heaters 18 arranged to extend in perpendicular relation to the blades 12. Additionally the covers 30 serve to deflect heat produced by the heaters 18 in the direction of the cutting edge of the blades 12. Referring specifically to FIG. 4, when the heating system for a razor is activated, the wires 24 are supplied with an electric current from the electric power source 22 and the current flows to the heaters 18 and heat is generated. A radiator effect is created as a result of the heat produced by the heaters 18 passing between the blades 12 towards the cutting edge of the blades 12. In a preferred embodiment, the resistance of the heaters 18 is higher than the resistance of the wires 24 for maximizing the efficiency of the heat produced by the heaters 18 to prevent thermal runaway.

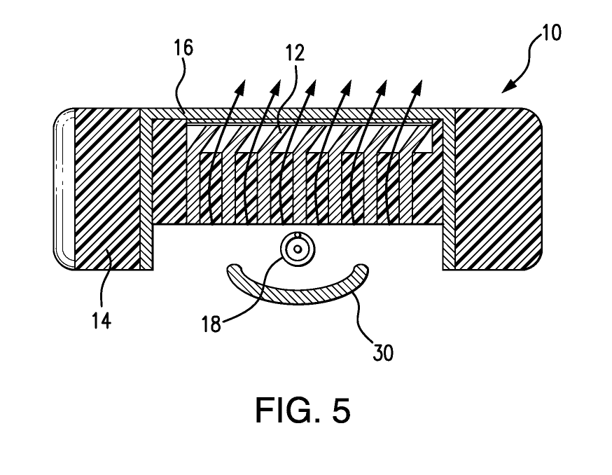

Referring to FIG. 5, one or more heaters 18 could also be arranged to extend parallel in relation to the blades 12 along a portion or the entire length of the blades 12.

While the present invention has been shown and described in accordance with several preferred and practical embodiments, it is recognized that departures from the instant disclosure are contemplated within the spirit and scope of the present invention which are not to be limited except as defined in the following claims as interpreted under the Doctrine of Equivalents.

What is claimed is:

1. A razor for shaving and comprising:
at least one blade having a front cutting edge and a rear non-cutting edge; and
at least one heater positioned and disposed in spaced, adjacent relation to the rear non-cutting edge of said at least one blade, and said at least one heater being in connection with an electric power source for delivering an electric current to said at least one heater for producing a radiator effect wherein heat produced by said at least one heater is directed towards the front cutting edge of said at least one blade.

2. The razor as recited in claim 1 wherein said at least one heater is at least one closed coil heating element.

3. The razor as recited in claim 1 wherein said at least one heater is at least on opened coil heating element.

4. The razor as recited in claim 1 wherein said at least one heater is made from a resistive conductor.

5. The razor as recited in claim 4 wherein the resistive conductor is Nichrome.

6. The razor as recited in claim 1 wherein said at least one heater is disposed in parallel relation to the rear non-cutting edge of said at least one blade.

7. The razor as recited in claim 1 wherein said at least one heater is disposed in perpendicular relation to the rear non-cutting edge of said at least one blade.

8. A razor for shaving and comprising:
a plurality of blades, and each of said plurality of blades having a front cutting edge and a rear non-cutting edge;
a blade cartridge being structured and disposed for holding said plurality of blades;
an electric power source; and
at least one heater on said blade cartridge, and said at least one heater being positioned and disposed in spaced, adjacent relation to the rear non-cutting edge of each of said plurality of blades, and said at least one heater being in connection with the electric power source for delivering an electric current to said at least one heater for producing a radiator effect wherein heat produced by said at least one heater is directed towards the front cutting edge of each of said plurality of blades.

9. The razor as recited in claim 8 wherein said at least one heater is at least one closed coil heating element.

10. The razor as recited in claim 8 wherein said at least one heater is at least on opened coil heating element.

11. The razor as recited in claim 8 wherein said at least one heater is made from a resistive conductor.

12. The razor as recited in claim 11 wherein the resistive conductor is Nichrome.

13. The razor as recited in claim 8 wherein said at least one heater is disposed in parallel relation to the rear non-cutting edge of each of said plurality of blades.

14. The razor as recited in claim 8 wherein said at least one heater is disposed in perpendicular relation to the rear non-cutting edge of each of said plurality of blades.

15. The razor as recited in claim 8 wherein said electric power source is a battery.
